(19) United States
(12) Patent Application Publication
(10) Pub. No.: US 2026/0250101 A1
(43) Pub. Date: Aug. 27, 2026

(54) ELEVATOR LONG-OBJECT CHECKING DEVICE

(71) Applicant: Mitsubishi Electric Corporation, Tokyo (JP)

(72) Inventors: Hiroshi FUKUNAGA, Tokyo (JP); Satoshi SHIGA, Tokyo (JP); Masashi KAMIYA, Tokyo (JP); Takahide HIRAI, Tokyo (JP)

(73) Assignee: Mitsubishi Electric Corporation, Tokyo (JP)

(21) Appl. No.: 18/870,476

(22) PCT Filed: Jun. 7, 2022
(86) PCT No.: PCT/JP2022/022922

§ 371 Date: Nov. 29, 2024

(51) Int. Cl. B66B 7/12; G06T 3/4038; G06T 7/00; G06T 7/13; G06T 7/277; G06T 7/70; G06V 10/74

(52) U.S. Cl. CPC B66B 7/1238; G06T 3/4038; G06T 7/0002; G06T 7/13; G06T 7/277; G06T 7/70; G06V 10/761; G06T 2207/20081

(57) ABSTRACT

For an elevator where a long-object checking device is applied, a camera images a position above or below a car so that an imaged range includes a long object and a grooved wheel. A grooved wheel detection unit performs an image processing process to detect a part rendering the grooved wheel from an image taken by the camera. A long-object detection unit performs an image processing process to detect a part rendering the long object from the image taken by the camera, by referring to a position of the part rendering the grooved wheel detected by the grooved wheel detection unit. A judgment unit judges whether the abnormality of the long object exists or is absent, on a basis of a condition of the detected long object.

### TECHNICAL FIELD

The present disclosure is related to an elevator long-object checking device.

### BACKGROUND ART

PTL 1 discloses an example of an elevator long-object checking device. The long-object checking device includes a camera, an image processing device, and a judgment device. The camera is provided for a car running in a hoistway. The camera images a position above the car so that an image includes a main rope being a long object. The image processing device performs an image processing process to extract a part rendering the main rope from the image taken by the camera. By using the processed image, which is the image on which the image processing process was performed by the image processing device, the judgment device judges whether or not the main rope is caught on a catching object in the hoistway.

### CITATION LIST

### Patent Literature

[PTL 1] JP 2015-20863 A

### SUMMARY OF THE INVENTION

### Problems to be Solved by the Invention

Other than the long object such as the main rope to be subjected to the judgment about whether an abnormality (e.g., the long object being caught) exists or is absent, the hoistway of the elevator is also provided with other long objects and the like that are not subjected to the abnormality judgment process. In addition, an inner wall of the hoistway may have linear texture or the like in some situations. For this reason, if the long-object checking device in PTL 1 erroneously detects one of the long objects not subjected to the judgment process or the linear texture, as a long object to be subjected to the judgment process, there is a possibility that an abnormality (e.g., a long object being caught) may be erroneously detected.

The present disclosure is for solving the problem described above. The present disclosure provides a long-object checking device capable of more accurately detecting an abnormality of a long object of an elevator.

### Means to Solve the Problem

A long-object checking device according to the present disclosure, which detects an abnormality of a long object wound and hung around a grooved wheel in a hoistway in which a car of an elevator runs, the long-object checking device includes: an imaging unit that images one or both of a position above and a position below the car so that an imaged range includes the long object and the grooved wheel; an image processing unit that performs an image processing process to detect a part rendering the long object from an image taken by the imaging unit; and a judgment unit that judges whether the abnormality of the long object exists or is absent, on a basis of a condition of the long object detected by the image processing unit, wherein the image processing unit includes: a grooved wheel detection unit that performs an image processing process to detect a part rendering the grooved wheel from the image taken by the imaging unit; and a long-object detection unit that performs an image processing process to detect the part rendering the long object from the image taken by the imaging unit, by referring to a position of the part rendering the grooved wheel detected by the grooved wheel detection unit.

A long-object checking device according to the present disclosure, which detects an abnormality of a long object wound and hung around a grooved wheel in a hoistway in which a car of an elevator runs, the long-object checking device includes: an image processing unit that performs an image processing process to detect a part rendering the long object from an image taken by an imaging unit that images one or both of a position above and a position below the car so that an imaged range includes the long object and the grooved wheel; and a judgment unit that judges whether the abnormality of the long object exists or is absent, on a basis of a condition of the long object detected by the image processing unit, wherein the image processing unit includes: a grooved wheel detection unit that performs an image processing process to detect a part rendering the grooved wheel from the image taken by the imaging unit; and a long-object detection unit that performs an image processing process to detect the part rendering the long object from the image taken by the imaging unit, by referring to a position of the part rendering the grooved wheel detected by the grooved wheel detection unit.

### Advantageous Effects of the Invention

The long-object checking device according to the present disclosure makes it possible to more accurately detect the abnormality of the long object of the elevator.

### BRIEF DESCRIPTION OF DRAWINGS

FIG. 1 is a side view showing a configuration of an elevator according to the first embodiment.

FIG. 2 is a block diagram showing functions of a long-object checking device according to the first embodiment.

FIG. 3 is a drawing showing an example of an image taken by a camera according to the first embodiment.

FIG. 4 is a side view showing a condition in which an abnormality has occurred to a governor rope of the elevator according to the first embodiment.

FIG. 5 is a drawing showing an example of an image taken by the camera when an abnormality has occurred to the governor rope of the elevator according to the first embodiment.

FIG. 6 is a drawing showing the location where the abnormality has occurred to the governor rope of the elevator according to the first embodiment.

FIG. 7 is a drawing showing the location where the abnormality has occurred to the governor rope of the elevator according to the first embodiment.

FIG. 8 is a flowchart showing the example of the motion of the long-object checking device according to the first embodiment.

FIG. 9 is a hardware configuration diagram of a main part of the long-object checking device according to the first embodiment.

FIG. 10 is a block diagram showing functions of the long-object checking device according to the second embodiment.

FIG. 11 is a drawing showing an example of a panorama image of a hoistway according to the second embodiment

### DESCRIPTION OF EMBODIMENTS

Embodiments for carrying out what is disclosed herein will be explained, with reference to the accompanying drawings. In the drawings, some of the elements that are the same as or correspond to each other will be referred to by using the same reference signs, and duplicate explanations will be simplified or omitted as appropriate. In addition, what is disclosed herein is not limited to the following embodiments, and it is possible to modify arbitrary constituent elements of the embodiments or to omit arbitrary constituent elements of the embodiments, without departing from the gist of the present disclosure.

### First Embodiment

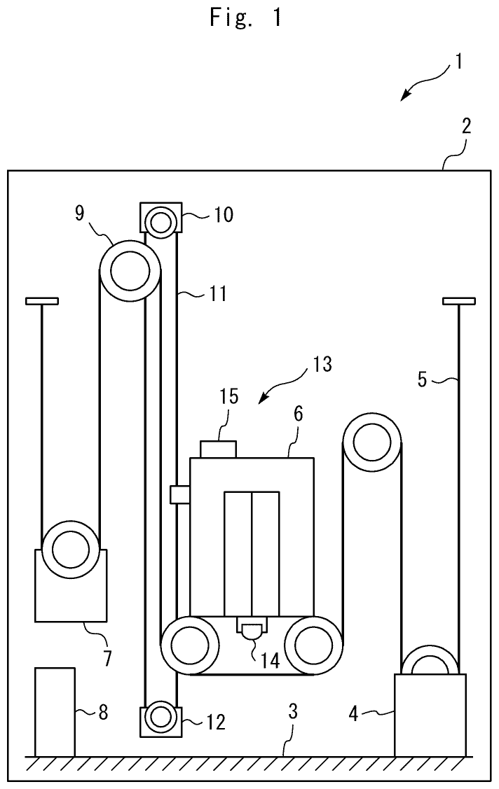

FIG. 1 is a side view showing a configuration of an elevator 1 according to the first embodiment.

The elevator 1 is applied to a building having a plurality of floors. FIG. 1 shows an example of the elevator 1 as viewed from a side. A hoistway 2 for the elevator 1 is provided in the building. The hoistway 2 is a long space extending in up-and-down directions between the plurality of floors. A pit 3 is provided in a lower end part of the hoistway 2. The elevator 1 includes a traction machine 4, a main rope 5, a car 6, a counterweight 7, and a control panel 8.

The traction machine 4 includes a sheave and a motor. The sheave of the traction machine 4 is connected to a rotation hoistway of the motor of the traction machine 4. The motor of the traction machine 4 is equipment that generates a driving force to rotate the sheave of the traction machine 4.

The main rope 5 is wound and hung around the sheave of the traction machine 4. The main rope 5 supports a load of the car 6, by hanging the car 6 in the hoistway 2.

The main rope 5 supports a load of the counterweight 7, by hanging the counterweight 7 in the hoistway 2. In the present example, the main rope 5 is wound and hung around a return pulley 9. The main rope 5 supports the load of the car 6 on one side of the return pulley 9. The main rope 5 supports the load of the car 6 on the other side of the return pulley 9.

As the main rope 5 moves due to rotation of the sheave of the traction machine 4, the car 6 and the counterweight 7 run in opposite directions in the hoistway 2. The car 6 is equipment that transports passengers and the like between the plurality of floors, by running in the up-and-down directions inside the hoistway 2. The counterweight 7 is equipment that balances the car 6 with the load applied to the main rope 5 on either side of a pulley such as the return pulley 9 on which the main rope 5 is wound and hung around.

The control panel 8 is equipment that controls motion of the elevator 1. For example, the control panel 8 controls the running of the car 6. The control panel 8 has installed therein a function to obtain the position of the car 6 within the hoistway 2.

The elevator 1 includes a governor 10, a governor rope 11, and a tension pulley 12. The governor 10 is equipment that inhibits excessive running speeds of the car 6. The governor 10 includes a pulley. The governor rope 11 is wound and hung around the pulley of the governor 10. Both ends of the governor rope 11 are attached to the car 6. The governor rope 11 is wound and hung around the tension pulley 12. The tension pulley 12 is a pulley that applies tension to the governor rope 11, For example, the tension pulley 12 may be provided in the pit 3. The pulley of the governor 10 rotates in coordination with moving of the car 6, via the governor rope 11 connected to the car 6. When a rotation speed of the pulley is excessive, the governor 10 inhibits the excessive running speed of the car 6.

To the elevator 1, a long-object checking device 13 is applied. The long-object checking device 13 is a device that detects an abnormality of a long object in the hoistway 2. The long object to be subjected to the abnormality detection by the long-object checking device 13 is equipment that is long in one direction. When there is no abnormality, the longitudinal direction of the long object is parallel to the running direction of the car 6. In the present example, the long object moves in the hoistway 2 in conjunction with operations of the elevator 1. For example, the long object may be the main rope 5, the governor rope 11, or the like. The long object may be a counterweight rope (not shown) that compensates an imbalance between a dead load of the main rope 5 on the car 6 side and a dead load of the main rope 5 on the counterweight 7 side which occurs due to the moving of the main rope 5. The long object may be a control cable used for communicating an electrical signal or supplying electric power. In other examples, the long object may be a strand rope or may be a belt or a chain. The long object is wound and hung around a grooved wheel. For example, the grooved wheel may be a pulley such as the sheave of the traction machine 4, the pulley of the governor 10, the return pulley 9, the tension pulley 12, a diverting pulley, or a suspension pulley. For example, the grooved wheel includes a part in which the long object passes through or reverses itself. The long-object checking device 13 includes a camera 14 and a data processing device 15.

The camera 14 has installed therein a function to image the inside of the hoistway 2. The camera 14 is an example of the imaging unit. The camera 14 images the inside of the hoistway 2 so that an imaged range includes the long object and the grooved wheel on which the long object is wound and hung around. In the present example, the camera 14 is attached to the bottom side of the floor of the car 6. For example, the camera 14 images a position below the car 6. Alternatively, the camera 14 may be attached to the top side of the ceiling of the car 6. In that situation, for example, the camera 14 images a position above the car 6. In yet another example, the camera 14 may be installed in the hoistway 2. In that situation, for example, the camera 14 images a lower part of the hoistway 2.

The imaging unit may be a camera that images both a position above and a position below the car 6. Further, the imaging unit may include a plurality of cameras. In that situation, the imaging unit may include a camera that images a position above the car 6 and another camera that images a position below the car 6. Further, the long-object checking device 13 may use a camera of an external device as the imaging unit. In other words, the data processing device 15 of the long-object checking device 13 may detect the abnormality of the long object by using an image taken by the camera of the external device.

The data processing device 15 is a part being in charge of data processing regarding the detection of the abnormality of the long object. The data processing device 15 is connected to the camera 14 so as to be able to obtain the image taken by the camera 14. The data processing device 15 may be provided on the top of the car 6, for example.

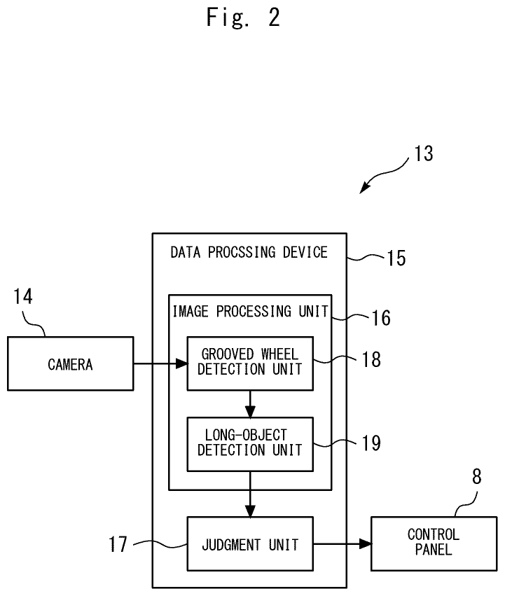

FIG. 2 is a block diagram showing functions of the long-object checking device 13 according to the first embodiment.

The data processing device 15 includes an image processing unit 16 and a judgment unit 17. The image processing unit 16 is a part having installed therein a function to perform an image processing process for detecting the long object, from the image taken by the camera 14. The image processing unit 16 has installed therein a function to obtain the image taken by the camera 14. The judgment unit 17 is a part having installed therein a function to judge whether an abnormality of the long object exists or is absent, on the basis of a condition of the long object detected by the image processing unit 16. The judgment unit 17 has installed therein a function to output, to the control panel 8, a judgment result regarding whether the abnormality exists or is absent, and the like. The image processing device includes a grooved wheel detection unit 18 and a long-object detection unit 19.

The grooved wheel detection unit 18 has installed therein a function to perform an image processing process for detecting a part rendering the grooved wheel on which the long object is wound and hung around, from the image taken by the camera 14.

The grooved wheel detection unit 18 detects the part rendering the grooved wheel by implementing, for example, a template matching method. The grooved wheel detection unit 18 calculates a similarity level with respect to each of different parts of the image taken by the camera 14, by making a comparison with a template image being set in advance and representing a correct answer image of the grooved wheel. In this situation, for example, the grooved wheel detection unit 18 detects a part of which the calculated similarity level is equal to or higher than a similarity threshold value set in advance, as the part rendering the grooved wheel.

The grooved wheel detection unit 18 may specify the part rendering the grooved wheel, by learning feature values in images by implementing a machine learning method and employing a discriminator using the feature values. For example, as the feature values, the grooved wheel detection unit 18 may use a Histogram of Oriented Gradients (HOG) or a Scale Invariant Feature Transform (SIFT) scheme. For example, as the discriminator, the grooved wheel detection unit 18 may use a Support Vector Machine (SVM). The grooved wheel detection unit 18 may specify the part rendering the grooved wheel by implementing a deep learning method.

Alternatively, the grooved wheel detection unit 18 may detect a marker attached to the grooved wheel so as to detect the grooved wheel on the basis of a result of the marker detection. Examples of the marker attached to the grooved wheel include a sticker pasted so as to indicate a color set in advance or a code expressed in a pattern. The grooved wheel detection unit 18 may narrow down an area including the part rendering the grooved wheel from the image taken by the camera 14, on the basis of the type of or installation information on the elevator 1. In that situation, the grooved wheel detection unit 18 performs an image processing process to detect the part rendering the grooved wheel from the narrowed-down area. The information about the type of the elevator 1 may include information about the model or a model number of the elevator 1, for example. The installation information on the elevator 1 includes information about the installation position of the grooved wheel or the like. The type of or the installation information on the elevator 1 may be set in the grooved wheel detection unit 18 in advance or may be obtained by the grooved wheel detection unit 18 from the control panel 8 of the elevator 1 or the like.

The long-object detection unit 19 performs an image processing process to detect a part rendering the long object from the image taken by the camera 14, by referring to the position of the part rendering the grooved wheel detected by the grooved wheel detection unit 18.

For example, the long-object detection unit 19 detects the part rendering the long object by implementing an edge detecting method. For example, from among detected edges, the long-object detection unit 19 detects an edge passing through the part rendering the grooved wheel, as the part rendering the long object. The long-object detection unit 19 specifies the part rendering the long object, by specifying a linear object that extends starting at the part rendering the grooved wheel detected by the grooved wheel detection unit 18, while employing an edge detector. For example, the long object linearly extends along the running direction of the car 6, starting at the grooved wheel.

The long-object detection unit 19 may detect the part rendering the long object by implementing a local similarity judging method. For example, along the running direction of the car 6, the long-object detection unit 19 may sequentially extract local images each having a size set in advance, from the image taken by the camera 14, starting at the part rendering the grooved wheel detected by the grooved wheel detection unit 18. The long-object detection unit 19 calculates a similarity level between parts in sets of local images adjacent to each other among the extracted local images. In this situation, for example, the sets of adjacent local images may each be a set of local images adjacent in the running direction of the car 6 or may each be a set of local images between which the distance in the running direction of the car 6 within the image taken by the camera 14 is shorter than a distance set in advance. The long-object detection unit 19 detects the part rendering the long object, by performing a tracking process while giving priority to certain parts having higher similarity levels between adjacent local images, among the extracted local images. As a method for sequentially detecting the part rendering the long object starting from the position of the grooved wheel, the long-object detection unit 19 may employ a tracking filter, which is used in image recognition processes and the like. For example, the long-object detection unit 19 may detect the part rendering the long object, by tracking the part rendering the long object starting from the position of the grooved wheel, while employing a particle filter, a Kalman filter, or the like.

On the basis of the condition of the long object detected by the long-object detection unit 19, the judgment unit 17 makes the judgment about whether the abnormality of the long object exists or is absent. For example, on the basis of the position, the orientation, or the shape of the detected long object, the judgment unit 17 judges whether the abnormality of the long object exists or is absent. The judgment unit 17 outputs the judgment result regarding whether the abnormality of the long object exists or is absent, to the control panel 8, for example.

The judgment unit 17 may calculate a reliability level of the long-object detection by the long-object detection unit 19. For example, when the long-object detection unit 19 detects the long object by using the edge detector, the similarity levels between the local images, or the tracking filter, the judgment unit 17 may calculate the reliability level of the detection on the basis of a strength or a likelihood of the edge. The judgment unit 17 outputs information about the calculated reliability level to the control panel 8, together with the judgment result, for example.

Further, the judgment unit 17 may calculate the position, within the hoistway 2, of a location where the abnormality of the long object was detected. The judgment unit 17 may calculate the position of the location within the hoistway 2, on the basis of the position, within the image, of the location where the abnormality was detected. In that situation, for example, the judgment unit 17 may calculate the position of the location within the hoistway 2, by using, as a reference, the part rendering the grooved wheel detected by the grooved wheel detection unit 18. Also, in that situation, the judgment unit 17 may use information about the position of the car 6 when the image was taken, or the like. For example, the judgment unit 17 outputs the information about the calculated position of the abnormality detection location to the control panel 8, together with the judgment result.

The control panel 8 may control motion of the elevator 1, in accordance with the judgment result input thereto from the judgment unit 17. For example, upon receipt of a judgment result indicating that there is no abnormality, the control panel 8 continues the operation of the elevator 1 without stopping the operation. On the contrary, upon receipt of a judgment result indicating that there is an abnormality, the control panel 8 stops the operation of the elevator 1. The control panel 8 may perform a process in accordance with a reliability level of the judgment result. For example, upon receipt of a judgment result indicating that there is an abnormality and having a reliability level higher than a threshold value set in advance, the control panel 8 continues the operation of the elevator 1 without the need to have a confirmation from a person such as a maintenance person. In that situation, if the elevator 1 has been stopped, the control panel 8 may resume the operation of the elevator 1 without the need to have a confirmation from a person such as a maintenance person. In contrast, upon receipt of a judgment result indicating that there is no abnormality and having a reliability level lower than the threshold value set in advance, the control panel 8 may notify a maintenance person or the like of the judgment result. In that situation, the control panel 8 may stop the operation of the elevator 1 until a person such as a maintenance person confirms the condition of the long object by visiting the actual site. Together with the judgment result, the control panel 8 may issue a notification about the reliability level or the position of the abnormality detection location calculated by the judgment unit 17.

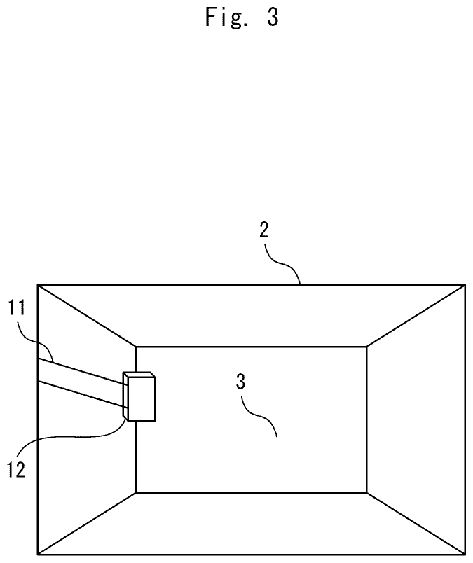

FIG. 3 is a drawing showing an example of the image taken by the camera 14 according to the first embodiment.

In the present example, the long-object checking device 13 detects abnormalities of a governor rope 11 serving as the long object. The long-object checking device 13 first detects the tension pulley 12 serving as an example of the grooved wheel and subsequently detects the abnormalities, if any, of the governor rope 11. In FIG. 3, structures other than the governor rope 11 and the tension pulley 12 are omitted from the drawing.

Further, the long-object checking device 13 may detect an abnormality of a long object with respect to another set made up of a long object and a grooved wheel. The set made up of a long object and a grooved wheel to be subjected to the detection by the long-object checking device 13 may be, for example, a set made up of the governor rope 11 and a pulley of the governor 10; a set made up of the main rope 5 and the sheave of the traction machine 4; and a set made up of a counterweight rope and a pulley on which the rope is wound and hung around.

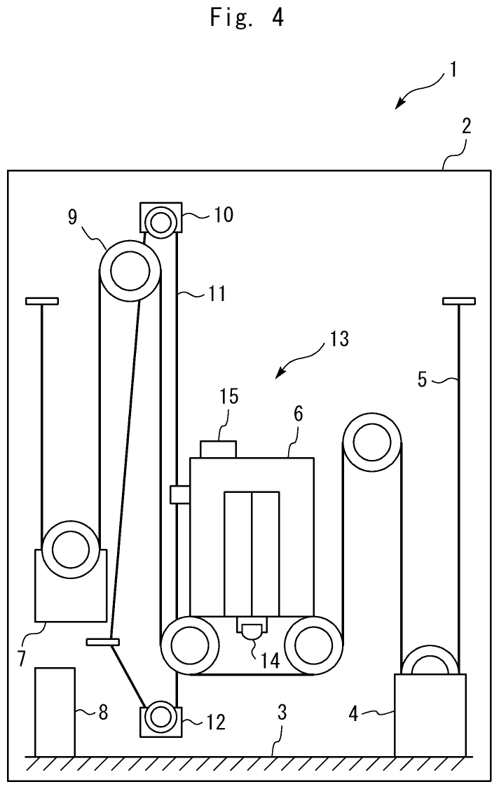

Next, an example of the detection of the abnormality of the long object performed by the long-object checking device 13 will be explained, with reference to FIGS. 4 to 7.

In the present example, as the abnormality of the long object, the long-object checking device 13 detects whether the governor rope 11 wound and hung around the tension pulley 12 is caught on a structure in the hoistway 2 or the car 6. Examples of the structure in the hoistway 2 include a casing of equipment in the hoistway 2, a support. a frame, a beam, a column, or a bracket.

FIG. 4 is a side view showing a condition in which an abnormality has occurred to the governor rope 11 of the elevator 1 according to the first embodiment.

FIG. 1 shows the elevator 1 in the condition where the governor rope 11 has no abnormality. In contrast, FIG. 4 shows the elevator 1 in a condition where the governor rope 11 is caught on a structure in the hoistway 2.

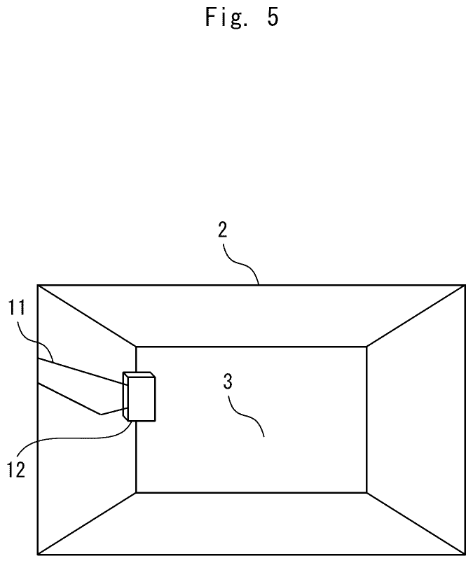

FIG. 5 is a drawing showing an example of an image taken by the camera 14 when an abnormality has occurred to the governor rope 11 of the elevator 1 according to the first embodiment.

FIG. 3 shows the example of the image taken when the governor rope 11 has no abnormality. In contrast, FIG. 5 shows the example of the image taken when the governor rope 11 is caught on the structure in the hoistway 2. In the present example, the structure in the hoistway 2 is omitted from the drawing.

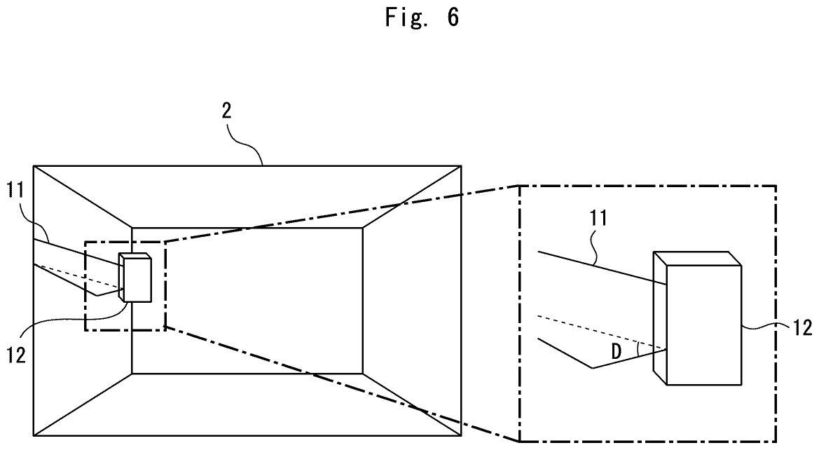

FIG. 6 is a drawing showing the location where the abnormality has occurred to the governor rope 11 of the elevator 1 according to the first embodiment.

FIG. 6 shows an enlarged view of the location where the rope is caught on the structure. The dashed line in FIG. 6 shows the condition of the governor rope 11 that would be observed if the rope were not caught on the structure in the hoistway 2. The condition such as the orientation and the position of the governor rope 11 that would be observed if the rope were not caught is obtained in advance, while there is no occurrence of abnormalities. The condition such as the orientation and the position of the governor rope 11 that would be observed if the rope were not caught may be obtained in advance, for example, at the time of installing the elevator 1 or at the time of a periodical inspection of the elevator 1. The long-object checking device 13 stores the obtained condition in a memory.

Because the rope is caught on the structure, an angle D is formed between the orientation of the governor rope 11 that extends starting at the tension pulley 12 and the orientation of the governor rope 11 in the condition that would be observed if the rope were not caught. For example, the judgment unit 17 calculates the angle D, on the basis of the detection result of the long-object detection unit 19. For example, when the calculated angle D is equal to or larger than an angle threshold value set in advance, the judgment unit 17 judges that the governor rope 11 is caught on a structure and has an abnormality.

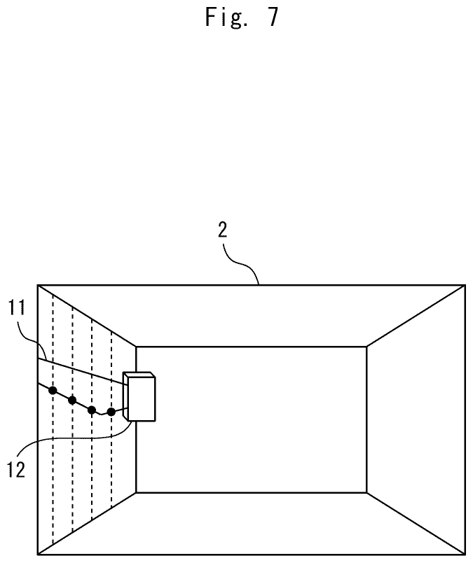

FIG. 7 is a drawing showing the location where the abnormality has occurred to the governor rope 11 of the elevator 1 according to the first embodiment.

FIG. 7 shows a plurality of sampling points on the detected long object. For example, the sampling points are sampled at equal intervals in the running direction of the car 6.

The judgment unit 17 may detect an abnormality of the long object on the basis of linearity of the detected long object. For example, the judgment unit 17 may calculate the orientation of each of the line segments connecting any two of the sampling points adjacent to each other in the running direction of the car 6, so as to judge, if the angle formed by the orientations of any two adjacent line segments is equal to or larger than a threshold value set in advance, that the governor rope 11 is caught on a structure and has an abnormality.

In this situation, the long-object checking device 13 may detect other abnormalities besides the long object being caught. The long-object checking device 13 may detect an abnormality such as the long object having broken, a damage such as a strand having broken, or a tension defect. For example, the long-object checking device 13 may detect the breakage of the long object, on the basis of continuity of the detected long object or the like. For example, the long-object checking device 13 may detect a local damage or the like, on the basis of a change in image similarity levels along the longitudinal direction of the detected long object. For example, the long-object checking device 13 may detect the tension defect or the like, on the basis of linearity of the detected long object.

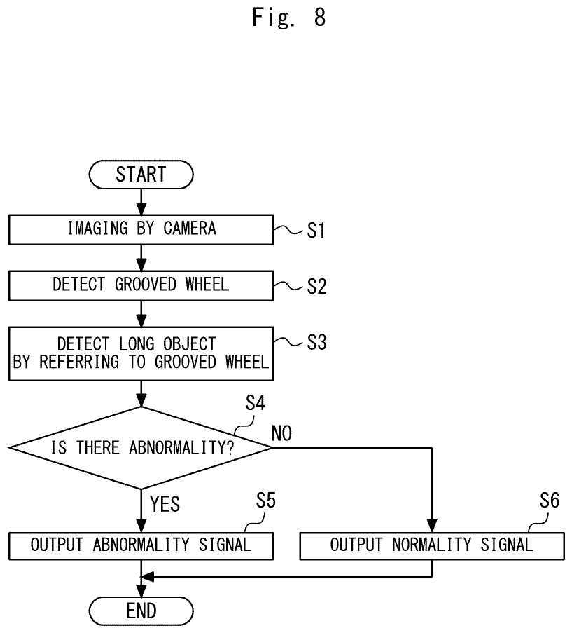

Next, an example of motion of the long-object checking device 13 will be explained, with reference to FIG. 8.

FIG. 8 is a flowchart showing the example of the motion of the long-object checking device 13 according to the first embodiment.

The processes in FIG. 8 may be performed, for example, when occurrence of an earthquake is detected in the elevator 1. The processes in FIG. 8 may constantly be performed during the operation of the elevator 1 or may be performed with regular or irregular timing set in advance. Further, the processes in FIG. 8 may be performed on the basis of an operation performed by a maintenance person or a manager or may be performed on the basis of occurrence of an event detected in the elevator 1.

In step S1, the camera 14 takes an image of the hoistway 2. After that, the process of the long-object checking device 13 proceeds to step S2.

In step S2, the grooved wheel detection unit 18 performs the process of detecting the grooved wheel from the image taken by the camera 14. The grooved wheel detection unit 18 outputs the information about the part rendering the grooved wheel detected from the image. After that, the process of the long-object checking device 13 proceeds to step S3.

In step S3, the long-object detection unit 19 performs the process of detecting the part rendering the long object by referring to the position of the part rendering the grooved wheel output by the grooved wheel detection unit 18. The long-object detection unit 19 outputs the information about the part rendering the long object detected from the image. After that, the process of the long-object checking device 13 proceeds to step S4.

In step S4, the judgment unit 17 judges whether there is an abnormality such as the long object being caught, on the basis of the condition of the part rendering the long object output by the long-object detection unit 19. When there is an abnormality, the process of the long-object checking device 13 proceeds to step S5. On the contrary, when there is no abnormality, the process of the long-object checking device 13 proceeds step S6.

In step S5, the judgment unit 17 outputs an abnormality signal to the control panel 8. After that, the process of the long-object checking device 13 completes.

In step S6, the judgment unit 17 outputs a normality signal to the control panel 8. After that, the process of the long-object checking device 13 completes.

As explained above, the long-object checking device 13 according to the first embodiment detects the abnormality of the long object wound and hung around the grooved wheel in the hoistway 2. As for the elevator 1, the camera 14 is provided for the car 6 running in the hoistway 2. The camera 14 images one or both of a position above and a position below the car 6, so that the imaged range includes the long object and the grooved wheel. The long-object checking device 13 includes the image processing unit 16 and the judgment unit 17. The image processing unit 16 performs the image processing process to detect the part rendering the long object from the image taken by the camera 14. On the basis of the condition of the long object detected by the image processing unit 16, the judgment unit 17 judges whether an abnormality of the long object exists or is absent. The image processing unit 16 includes the grooved wheel detection unit 18 and the long-object detection unit 19. The grooved wheel detection unit 18 performs the image processing process to detect the part rendering the grooved wheel from the image taken by the camera 14. The long-object detection unit 19 performs the image processing process to detect the part rendering the long object from the image taken by the camera 14, by referring to the position of the part rendering the grooved wheel detected by the grooved wheel detection unit 18.

With the above configuration, because the part rendering the long object is detected by referring to the detected part rendering the grooved wheel, it is possible to more accurately detect the long object to be subjected to the judgment about whether an abnormality exists or is absent, even when the hoistway 2 has other long objects not subjected to the judgment process or linear texture. Consequently, it is possible to more accurately detect, from the elevator 1, the abnormality such as the long object being caught on a structure. When a disaster such as an earthquake has occurred in the place where the elevator 1 is provided, the elevator 1 may make an emergency stop. In that situation, to restore the operation of the elevator 1, it is important to confirm whether or not any of the long objects in the hoistway 2 such as the governor rope 11, the main rope 5, a counterweight rope, or a traveling cable is caught on a structure in the hoistway 2 or a part of the car 6. Having maintenance persons or the like visit and make the confirmations about a large number of elevators 1 one by one in the area that had an earthquake would require a huge amount of time and costs. In contrast, by detecting the long object being caught while using the camera 14 that images the inside of the hoistway 2, it is possible to reduce the time, the costs, and the like during situation responses after earthquakes. In addition, because the abnormality of the long object is detected more accurately, it is possible to more effectively reduce the time and the costs in the situation responses after earthquakes.

Further, the judgment unit 17 judges that the long object has an abnormality when the angle formed by the extending direction, within the image, of the long object detected by the long-object detection unit 19 and the extending direction, within the image, of the long object in the condition where the long object is not caught on any structure in the hoistway 2 is equal to or larger than the angle threshold value set in advance.

With the above configuration, because it is judged whether the catching exists or is absent, on the basis of a difference from the long object in the condition having no abnormality, it is possible to more definitely set a judgment standard for determining whether an abnormality exists or is absent.

Further, the grooved wheel detection unit 18 calculates the similarity level by comparing the parts of the image taken by the camera 14 with the template image set in advance. The grooved wheel detection unit 18 may detect a certain position of which the similarity level is equal to or higher than the similarity threshold value set in advance, as the part rendering the grooved wheel.

Further, the grooved wheel detection unit 18 may detect the part rendering the grooved wheel from the image taken by the camera 14, by implementing a machine learning method.

With the above configuration, the grooved wheel detection unit 18 is able to specify the position of the grooved wheel from the image taken by the camera 14.

Further, the grooved wheel detection unit 18 narrows down the area including the part rendering the grooved wheel, within the image taken by the camera 14, on the basis of the type of or the installation information on the elevator 1. The grooved wheel detection unit 18 performs the image processing process to detect the part rendering the grooved wheel from the narrowed-down area.

With the above configuration, the grooved wheel detection unit 18 is able to more accurately specify the position of the grooved wheel from the image taken by the camera 14.

Further, the long-object detection unit 19 detects the part rendering the long object, by specifying, while employing the edge detector, the linear object that extends starting at the part rendering the grooved wheel detected by the grooved wheel detection unit 18.

With the above configuration, the long-object detection unit 19 is able to more accurately detect the long object to be subjected to the judgment about whether an abnormality exists or is absent, from among the plurality of long objects in the hoistway 2.

Further, along the running direction of the car 6, the long-object detection unit 19 sequentially extracts the local images each having a size set in advance, starting at the part rendering the grooved wheel detected by the grooved wheel detection unit 18. The long-object detection unit 19 detects the part rendering the long object by sequentially performing the tracking process while giving priority to the certain parts having higher similarity levels between adjacent local images among the extracted local images.

With the above configuration, even when it is not possible to detect the edge locally due to an effect of natural light or lighting, the long-object detection unit 19 is able to detect the long object by sequentially following the local images while starting at the grooved wheel.

Further, the judgment unit 17 calculates the reliability level of the long-object detection by the long-object detection unit 19. The judgment unit 17 outputs the calculated reliability level, together with the judgment result regarding the abnormality of the long object.

With the above configuration, upon receipt of the judgment result from the judgment unit 17, a maintenance person or the like is able to determine an order in which a restoration procedure should be addressed, on the basis of the output reliability level.

Further, the judgment unit 17 calculates the position, within the hoistway 2, of the location where the abnormality of the long object was detected. The judgment unit 17 outputs the calculated position within the hoistway 2, together with the judgment result regarding the abnormality of the long object.

With the above configuration, upon receipt of the judgment result from the judgment unit 17, a maintenance person or the like is able to work after promptly understanding the position, within the hoistway 2, of the location that requires the restoration.

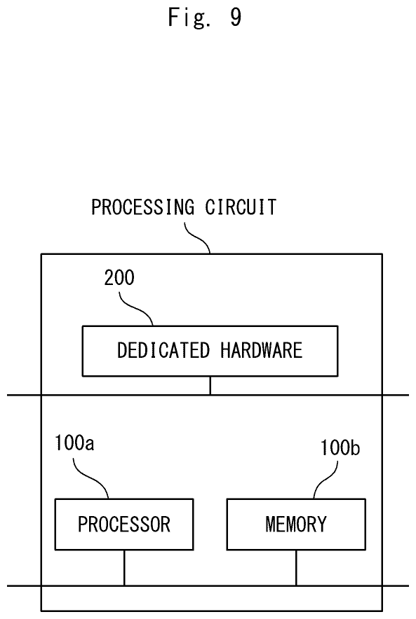

Next, an example of a hardware configuration of the long-object checking device 13 will be explained, with reference to FIG. 9.

FIG. 9 is a hardware configuration diagram of a main part of the long-object checking device 13 according to the first embodiment.

It is possible to realize functions of the long-object checking device 13 by using a processing circuit. The processing circuit includes at least one processor 100a and at least one memory 100b. In addition to or in place of the processor 100a and the memory 100b, the processing circuit may include at least one piece of dedicated hardware 200.

When the processing circuit includes the processor 100a and the memory 100b, the functions of the long-object checking device 13 are realized by using software, firmware, or a combination of software and firmware. At least one of the software and the firmware is written as a program. The program is stored in the memory 100b. The processor 100a realizes the functions of the long-object checking device 13, by reading and executing the program stored in the memory 100b.

The processor 100a may be referred to as a Central Processing Unit (CPU), a processing device, an arithmetic operation device, a microprocessor, a microcomputer, or a DSP. For example, the memory 100b may be configured by using a non-volatile or volatile semiconductor memory such as a RAM, a ROM, a flash memory, an EPROM, or an EEPROM.

When the processing circuit includes the dedicated hardware 200, the processing circuit is realized by using, for example, a single circuit, composite circuits, a programmed processor, parallel-programmed processors, an ASIC, an FPGA, or a combination of any of these.

It is possible to realize each of the functions of the long-object checking device 13 by using a processing circuit. Alternatively, it is also possible to collectively realize the functions of the long-object checking device 13 by using a processing circuit. It is also acceptable to realize a part of the functions of the long-object checking device 13 by using the dedicated hardware 200, while realizing the rest of the functions by using either software or firmware. As described herein, the processing circuit realizes the functions of the long-object checking device 13, by using the dedicated hardware 200, software, firmware, or a combination of any of these.

### Second Embodiment

In a second embodiment, some of the elements that are different from those in the examples disclosed in the first embodiment will be explained in detail in particular. For the features that are not explained in the second embodiment, it is acceptable to adopt any of the features in the examples disclosed in the first embodiment.

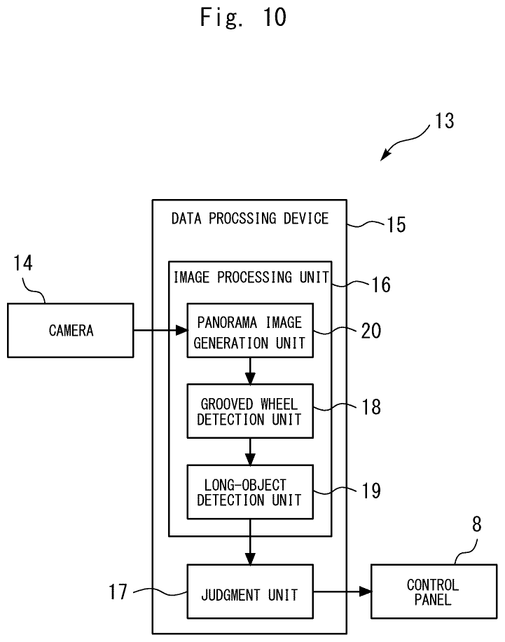

FIG. 10 is a block diagram showing functions of the long-object checking device 13 according to the second embodiment.

The image processing unit 16 includes a panorama image generation unit 20. The panorama image generation unit 20 is a part having installed therein a function to generate a panorama image by using images sequentially taken by the camera 14 while the car 6 is rising or descending. The panorama image generation unit 20 generates the panorama image, by cutting out and linking together parts of the images that were sequentially taken. The panorama image generation unit 20 may generate the panorama image by adding an image of the pit 3 taken by the camera 14 to the linked images. In the present example, the panorama image is a single image rendering the entirety of the hoistway 2. Further, in the situation where the pit 3 does not have the grooved wheel on which the long object to be subjected to the judgment process is wound and hung around, the panorama image generation unit 20 may generate the panorama image without adding the image of the pit 3 thereto.

The grooved wheel detection unit 18 detects the part rendering the grooved wheel, by using the panorama image generated by the panorama image generation unit 20. Further, the long-object detection unit 19 detects the part rendering the long object, by referring to the detected part rendering the grooved wheel while using the panorama image generated by the panorama image generation unit 20.

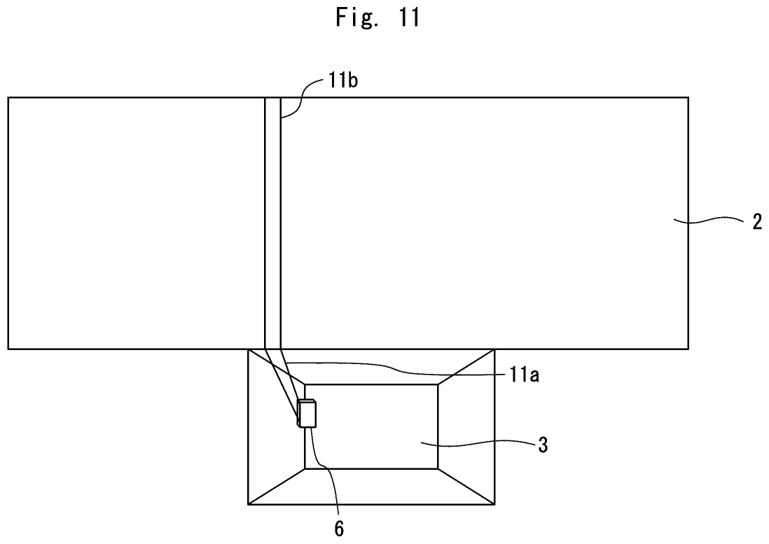

FIG. 11 is a drawing showing an example of the panorama image of the hoistway 2 according to the second embodiment.

In FIG. 11, the governor rope 11 in the image of the pit 3 is indicated with the reference sign 11a. Further, in the part obtained by linking together images of the hoistway 2, the governor rope 11 is indicated with the reference sign 11b.

In the panorama image generated in this manner, the governor rope 11 serving as the long object is rendered in continuity across the entirety of the hoistway 2. Consequently, the long-object detection unit 19 is able to detect the part rendering the governor rope 11 across the entirety of the hoistway 2, starting at the tension pulley 12 detected by the grooved wheel detection unit 18. In an example, the image processing unit 16 of the long-object detection device may exclude a boundary between the part obtained by linking together the images of the hoistway 2 and the image of the pit 3 from the long object abnormality judgment process.

As explained above, the image processing unit 16 of the long-object detection device according to the second embodiment includes the panorama image generation unit 20. The panorama image generation unit 20 generates the panorama image of the hoistway 2 along the running direction of the car 6, by linking together at least parts of the images sequentially taken by the camera 14 along the running direction of the car 6. The grooved wheel detection unit 18 performs the image processing process to detect the part rendering the grooved wheel from the panorama image generated by the panorama image generation unit 20. The long-object detection unit 19 performs the image processing process to detect the part rendering the long object from the panorama image generated by the panorama image generation unit 20, by referring to the position of the part rendering the grooved wheel detected by the grooved wheel detection unit 18.

Further, the panorama image generation unit 20 generates the panorama image so that the image of the pit 3 in the lower end part of the hoistway 2 is added thereto.

With the above configuration, the image processing unit 16 is able to use the panorama image being a single still image as a processing target. Consequently, it is possible to suppress a calculation load of the image processing unit 16 and a usage amount of the memory storing therein the images. In addition, long objects having no abnormality are rendered in the panorama image linearly along the running direction of the car 6. Consequently, it is possible to more definitely set the judgment standard for determining whether an abnormality (e.g., being caught) exists or is absent.

### INDUSTRIAL APPLICABILITY

The long-object checking device according to the present disclosure is applicable to elevators.

### REFERENCE SIGNS LIST

1 Elevator, 2 Hoistway, 3 Pit, 4 Traction machine, 5 Main rope, 6 Car, 7 Counterweight, 8 Control panel, 9 Return pulley, 10 Governor, 11 Governor rope, 12 Tension pulley, 13 Long-object checking device, 14 Camera, 15 Data processing device, 16 Image processing unit, 17 Judgment unit, 18 Grooved wheel detection unit, 19 Long-object detection unit, 20 Panorama image generation unit, 100a Processor, 100b Memory, 200 Dedicated hardware

1.-12. (canceled)

13. A long-object checking device that detects an abnormality of a long object wound and hung around a grooved wheel in a hoistway in which a car of an elevator runs, the long-object checking device comprising:
a camera that images one or both of a position above and a position below the car so that an imaged range includes the long object and the grooved wheel; and
processing circuitry
to perform an image processing process to detect a part rendering the long object from an image taken by the camera, and
to judge whether the abnormality of the long object exists or is absent, on a basis of a condition of the long object detected by the processing circuitry, wherein
the processing circuitry performs an image processing process to detect a part rendering the grooved wheel from the image taken by the camera; and
the processing circuitry performs an image processing process to detect the part rendering the long object from the image taken by the camera, by referring to a position of the part rendering the grooved wheel detected by the processing circuitry.

14. The long-object checking device according to claim 13, wherein
the processing circuitry judges that the long object has the abnormality, when an angle formed by an extending direction, within the image taken by the camera, of the long object detected by the processing circuitry and an extending direction, within the image, of the long object in a condition where the long object is not caught on any structure in the hoistway is equal to or larger than an angle threshold value set in advance.

15. The long-object checking device according to claim 13, wherein
the processing circuitry calculates a similarity level by comparing a part of the image taken by the camera with a template image set in advance and detects a position of which the similarity level is equal to or higher than a similarity threshold value set in advance, as the part rendering the grooved wheel.

16. The long-object checking device according to claim 13, wherein
from the image taken by the camera, the processing circuitry detects the part rendering the grooved wheel by implementing a machine learning method.

17. The long-object checking device according to claim 13, wherein
the processing circuitry narrows down an area including the part rendering the grooved wheel within the image taken by the camera, on a basis of a type of or installation information on the elevator and performs the image processing process to detect the part rendering the grooved wheel from the narrowed-down area.

18. The long-object checking device according to claim 13, wherein
the processing circuitry detects the part rendering the long object by specifying, while employing an edge detector, a linear object that extends starting at the part rendering the grooved wheel detected by the processing circuitry.

19. The long-object checking device according to claim 13, wherein
along a running direction of the car, the processing circuitry sequentially extracts local images each having a size set in advance, starting at the part rendering the grooved wheel detected by the processing circuitry and detects the part rendering the long object by sequentially performing a tracking process while giving priority to a certain part having a higher similarity level between adjacent local images among the extracted local images.

20. The long-object checking device according to claim 13, wherein
the processing circuitry calculates a reliability level of the detection of the long object by the processing circuitry and outputs the calculated reliability level together with a judgment result regarding the abnormality of the long object.

21. The long-object checking device according to claim 13, wherein
the processing circuitry calculates a position, within the hoistway, of a location where the abnormality of the long object was detected and outputs the calculated position within the hoistway, together with a judgment result regarding the abnormality of the long object.

22. The long-object checking device according to claim 13, wherein
the camera is provided for the car,
the processing circuitry generates a panorama image of the hoistway along a running direction of the car, by linking together at least parts of images sequentially taken by the camera along the running direction of the car,
the processing circuitry performs the image processing process to detect the part rendering the grooved wheel from the panorama image generated by the processing circuitry, and
the processing circuitry performs the image processing process to detect the part rendering the long object from the panorama image generated by the processing circuitry, by referring to a position of the part rendering the grooved wheel detected by the processing circuitry.

23. The long-object checking device according to claim 22, wherein
the processing circuitry generates the panorama image so that a pit image of a lower end part of the hoistway is added thereto.

24. A long-object checking device that detects an abnormality of a long object wound and hung around a grooved wheel in a hoistway in which a car of an elevator runs, the long-object checking device comprising:
processing circuitry
to perform an image processing process to detect a part rendering the long object from an image taken by a camera that images one or both of a position above and a position below the car so that an imaged range includes the long object and the grooved wheel; and
to judge whether the abnormality of the long object exists or is absent, on a basis of a condition of the long object detected by the processing circuitry, wherein
the processing circuitry performs an image processing process to detect a part rendering the grooved wheel from the image taken by the camera; and
the processing circuitry performs an image processing process to detect the part rendering the long object from the image taken by the camera, by referring to a position of the part rendering the grooved wheel detected by the processing circuitry.

25. The long-object checking device according to claim 24, wherein
the processing circuitry judges that the long object has the abnormality, when an angle formed by an extending direction, within the image taken by the camera, of the long object detected by the processing circuitry and an extending direction, within the image, of the long object in a condition where the long object is not caught on any structure in the hoistway is equal to or larger than an angle threshold value set in advance.

26. The long-object checking device according to claim 24, wherein
the processing circuitry calculates a similarity level by comparing a part of the image taken by the camera with a template image set in advance and detects a position of which the similarity level is equal to or higher than a similarity threshold value set in advance, as the part rendering the grooved wheel.

27. The long-object checking device according to claim 24, wherein
from the image taken by the camera, the processing circuitry detects the part rendering the grooved wheel by implementing a machine learning method.

28. The long-object checking device according to claim 24, wherein
the processing circuitry narrows down an area including the part rendering the grooved wheel within the image taken by the camera, on a basis of a type of or installation information on the elevator and performs the image processing process to detect the part rendering the grooved wheel from the narrowed-down area.

29. The long-object checking device according to claim 24, wherein
the processing circuitry detects the part rendering the long object by specifying, while employing an edge detector, a linear object that extends starting at the part rendering the grooved wheel detected by the processing circuitry.

30. The long-object checking device according to claim 24, wherein
along a running direction of the car, the processing circuitry sequentially extracts local images each having a size set in advance, starting at the part rendering the grooved wheel detected by the processing circuitry and detects the part rendering the long object by sequentially performing a tracking process while giving priority to a certain part having a higher similarity level between adjacent local images among the extracted local images.

31. The long-object checking device according to claim 24, wherein
the processing circuitry calculates a reliability level of the detection of the long object by the processing circuitry and outputs the calculated reliability level together with a judgment result regarding the abnormality of the long object.

32. The long-object checking device according to claim 24, wherein
the processing circuitry calculates a position, within the hoistway, of a location where the abnormality of the long object was detected and outputs the calculated position within the hoistway, together with a judgment result regarding the abnormality of the long object.

33. The long-object checking device according to claim 24, wherein
the camera is provided for the car,
the processing circuitry generates a panorama image of the hoistway along a running direction of the car, by linking together at least parts of images sequentially taken by the camera along the running direction of the car,
the processing circuitry performs the image processing process to detect the part rendering the grooved wheel from the panorama image generated by the processing circuitry, and
the processing circuitry performs the image processing process to detect the part rendering the long object from the panorama image generated by the processing circuitry, by referring to a position of the part rendering the grooved wheel detected by the processing circuitry.

34. The long-object checking device according to claim 33, wherein
the processing circuitry generates the panorama image so that a pit image of a lower end part of the hoistway is added thereto.
